(19) United States
(12) Patent Application Publication
(10) Pub. No.: US 2004/0031558 A1
(43) Pub. Date: Feb. 19, 2004

(54) Method for the connection of plastic pieces

(76) Inventor: Matthias Johnck, Munster (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/416,832

(22) PCT Filed: Sep. 1, 2001
(86) PCT No.: PCT/EP01/10093

(30) Foreign Application Priority Data
Nov. 16, 2000 (DE) 100 56 908.0

(51) Int. Cl. B44C 1/165

(52) U.S. Cl. 156/230; 156/240; 156/241

(57) ABSTRACT

The invention relates to a method for the connection of components, in particular micro-structured plastic components, whereby the adhesive is first applied to a support film, allowed to harden thereon and subsequently transferred to the micro-structured component The components are finally brought together. Said method avoids the ingress of adhesive into the channel system on applying the adhesive layer to the microstructured component.

The invention relates to a method for joining components which enables microstructured plastic parts to be adhesively bonded to one another with high precision and without impairing the structuring.

Miniaturised analytical systems, in particular those having a microfluidic channel structure, are of increasing importance. Analytical units which can be employed for such applications usually consist of a base plate (sub-strate) and a cover, between which microchannel structures, electrodes and other requisite functionalities, such as detectors, reactors, valves, etc., are located.

The demands to which a microfluidic analytical system has to be subjected include adequate stability with respect to mechanical, chemical, electrical and thermal influences. For the channel structures, mechanical stability means, in particular, dimensional and volume stability, which is an important prerequisite for, for example, quantitatively reproducible introduction of a sample. Internal pressure stability of the microchannels is also necessary with respect to the use of, for example, pumps for filling the microchannels. The materials used must of course be chemically inert to the medium transported in the channels. It should be possible to position any electrodes installed in the channel with high accuracy (a few μm) in the channel in order to be able to supply reproducible results, for example on use as detector electrode. A further prerequisite is that the contact surfaces inside the channel are free from impurities and thus have direct contact with the medium in the channels. The electrodes should furthermore allow low internal resistance and a potentially high current passage. This applies, in particular, to so-called power electrodes, with which an electrokinetic flow can be generated within the channels depending on the medium used. Finally, the electrodes should be easy to join.

The material used for the production of analytical units of this type is frequently silicon or glass. However, these materials have the disadvantage that they are not suitable for inexpensive mass production of the analytical systems. Plastic-based materials are significantly more suitable for this purpose. The components, such as substrate and cover, which contain the actual microstructures can then be produced inexpensively by known processes, such as hot embossing, injection moulding or reaction injection moulding.

By contrast, there are no techniques suitable for mass production for sealing the resultant open microstructures with covers for plastic components. This applies, in particular, to those having microchannel structures in which metallic electrodes are additionally to be positioned at any desired points inside a closed channel structure which have direct contact with the medium in the channels.

EP 0 738 306 describes a method for sealing microchannel structures in which a dissolved thermoplastic is spin-coated onto the structured polymer substrate. This dissolved thermoplastic has a lower melting point than the parts to be adhesively bonded. The thermal bonding of cover and substrate is carried out at 140° C. The surface of the channel thus consists of the thermoplastic adhesive. Comparable methods are described in WO 94/29400 and DE 198 46 958.

In U.S. Pat. No. 5,571,410, microfluidic structures are produced by laser ablation in Kapton™ and welded to a KJ®-coated Kapton™ film.

Becker et al. (H. Becker, W. Dietz, P. Dannberg, “Microfluidic manifolds by polymer hot embossing for μTAS applications”, Proceedings Micro Total Analysis Systems 1998, 253-256, Banff, Canada) report on the production of microfluidic channels in hot-embossed PMMA, which are sealed by chemically supported bonding to PMMA covers.

WO 97/38300 describes a method in which a cover is wetted with a homogeneous polydimethylsiloxane (PDMS) adhesive layer and bonded to an acrylic polymer-based fluidic structure.

A method for the thermal bonding of plastic parts is described in WO 99/51422. Here, an arrangement consisting of a microstructured component and a planar component is heated to temperatures just above the glass transition temperature. After cooling to below the glass transition temperature, a microfluidic system is obtained.

WO 99/25783 describes a method in which a microstructured component is strongly joined to a planar component by applying an organic solvent to one of the two plastic parts, placing the second component on top, and then pumping out the solvent. A strong join is obtained through the partial dissolution of the plastic parts.

Although all the abovementioned methods enable microchannel structures to be produced by joining a substrate to a cover, they do not, however, allow the integration of electrodes which have direct contact with the medium in the channels.

EP 0 767 257 describes a method for the integration of electrodes into microstructures, but this method does not allow liquid-isolated contacting since the channels have to be rinsed with metal-salt solutions for photochemical deposition of the metal therein.

A method for the integration of electrodes at any desired points inside a microstructured channel with the possibility of liquid-isolated contacting of the electrodes has been described by Fielden et al. (P. R.- Fielden, S. J. Baldock, N. J. Goddard, L. W. Pickering, J. E. Prest, R. D. Snook, B. J. T. Brown, D. I. Vaireanu, “A miniaturised planar isotachophoresis separation device for transition metals with integrated conductivity detection”, Proceedings Micro Total Analysis Systems '98, 323-326, Banff, Canada). The authors cast a microfluidic channel structure in silicone (PDMS) and pressed this mechanically against a board provided with electrodes (copper). The channels are thus delimited by two different materials. In order to keep the resultant channels closed, a constant mechanical pressure must be maintained. Due to the pressure on the silicone cushion, slight deformations of the channel structures arise in this system.

DE 199 27 533 describes a method for the production of microstructured analytical systems in which one component of the analytical system is wetted with adhesive by pad printing or roller application in such a way that the structured areas remain free from adhesive. The components are subsequently adjusted and pressed together.

The object of the present invention is to develop an improved method for joining microstructured components which is simple to carry out and gives good results with no flaws. A further object is to provide microfluid analytical systems whose substrate and cover preferably consist of polymeric organic materials and are strongly joined to one another and into which electrodes can be introduced at any desired point with means for liquid-isolated contacting.

It has been found that the adhesive bonding of microstructured components to one another can be carried out significantly more reliably and simply if the adhesive is not applied directly to one of the components, but instead is applied firstly to a support film. The adhesive layer is then transferred from the support film to the microstructured component, and the components are joined by known methods. In this way, the adhesive can pre-cure on the support film. After transfer to the actual substrate, there is no longer a risk of it flowing into the channel structure.

The present invention therefore relates to a method for joining components, characterised by the following steps:

a) provision of at least two components, where at least one component is microstructured;

b) application of an adhesive layer to a support film;

c) pre-curing of the adhesive layer on the support film;

d) transfer of the adhesive layer from the support film to at least one microstructured component;

e) adjustment and joining of the components;

f) complete curing of the adhesive layer.

In a preferred embodiment, the components provided in step a) consist of plastic.

In a preferred embodiment, at least one component provided in step a) has thin-film electrodes.

In a preferred embodiment, the support film is wetted in step b) by means of roller application, knife coating or pad printing.

In a preferred embodiment, the transfer of the adhesive layer to at least one microstructured component (step d)) is followed by an intermediate step d2) in which any parts of the adhesive layer lying over the micro-structuring, i.e., for example, over the channel system, are blown off using compressed air or removed by means of a soft brush.

In a preferred embodiment, the transfer of the adhesive layer from the support film to at least one microstructured component in step d) is carried out by joining the support film and the microstructured component, heating the arrangement to a temperature at which the adhesive layer softens, but which is below the softening point or glass transition temperature of the component and support film, cooling the arrangement, and peeling off the support film.

In a preferred embodiment, the complete curing of the adhesive layer in step f) is carried out by heating the joined components to a temperature at which the adhesive layer softens, but which is below the softening point or glass transition temperature of the components, and subsequently cooling the arrangement. In a further preferred embodiment, the thickness of the adhesive layer is from 1 to 20 μm.

The method according to the invention is suitable for the joining of components made from glass or preferably plastic. It is particularly suitable for joining components of which at least one is microstructured. The components are particularly preferably for the production of a micro-fluid or microstructured analytical system. These analytical systems generally consist of a flow unit which has at least the channel system and optionally recesses for the integration of peripheral devices, and peripheral devices, such as detectors, fluid connections, storage vessels, reaction chambers, pumps, control devices, etc., which can be integrated into the flow unit or joined thereto. The method according to the invention enables, through the joining of at least two components, such as, for example, substrate and cover, the production of flow units with microchannel structures which can be sealed so as to be liquid- and/or gas-tight. The substrate and cover are strongly joined to one another. In addition, these systems can contain electrodes at any desired point of the channel system which are in free contact with the interior of the channel, i.e. project into the channel system. All four sides of the channel also predominantly consist of the same material.

The components which can be bonded together by the method according to the invention are preferably made from commercially available thermoplastics, such as PMMA (polymethyl methacrylate), PC (polycarbonate), polystyrene or PMP (polymethylpentene), cycloolefinic homopolymers and copolymers or thermosetting plastics, such as, for example, epoxy resins. Preference is given to PC, and particular preference is given to PMMA. All components preferably consist of the same material.

The components can be produced by methods known to the person skilled in the art. Plastic components containing microstructures can be produced, for example, by established methods, such as hot embossing, injection moulding or reaction injection moulding. Particular preference is given to the use of components which can be duplicated by known mass-production methods. Microstructured components can have channel structures with cross-sectional areas of typically between 10 and 250,000 μm².

The electrodes introduced into the flow units according to the invention are typically employed for the generation of a flow of ions or for detection purposes. They must have adequate adhesive strength to the plastic components. This is of importance both for the joining of the individual components and for the later use of the analytical systems.

The main determining factor for the choice of electrode material is the planned use of the analytical system. Since systems having microchannel structures and integrated electrodes are essentially used in the area of analysis, the electrodes should consist of chemically inert materials, such as, for example, noble metals (platinum and gold).

The choice of such materials and application methods are known to the person skilled in the art, for example from DE 199 27 533 and WO 00/77509 (PCT/EP 00/05206) and the documents cited therein.

In a preferred embodiment of the method according to the invention, two components are joined. One component, for example the substrate, is microstructured and has the channel system and other recesses for the connection of further functionalities, such as, for example, fluid connections This component is preferably produced by means of an injection-moulding process.

The second component, in this case an electrode cover, has no micro-structuring. Instead, all electrodes are arranged on this component.

Examples of components or flow units for microstructured analytical systems which can be joined by the method according to the invention are given in DE 199 27 533, 199 27 534 and 199 27 535 and the corresponding applications WO 00/77509, WO 00/77507 and WO 00/77508, particularly in the figures shown and explained therein.

Suitable support films for the method according to the invention are polymer films made from materials which are only attacked by the adhesives used or the solvents present therein to an insignificant extent, or not at all, and to which the adhesives adhere less well than to the components. The support films preferably consist of polyethylene terephthalate (Mylar®) or polypropylene. It is also possible to use films made from highly fluorinated polymers, such as the FEP® film from Dupont. The thickness of the films should be such that the support films have adequate stability during the method according to the invention. Use is therefore preferably made of support films having a thickness of greater than 100 μm. In the case of the bonding of components having a surface which is planar overall, with the exception of the microstructuring, the support films can have any desired thickness and can even, if desired, have a plate-like character. However, preference is given to support films having a thickness of between 100 μm and 500 μm since these are capable of compensating for unevenness due to their flexibility during placing on the microstructured component. If a certain unevenness of the component cannot be compensated by the support film, direct contact between the component and the adhesive layer on the support film does not occur at certain points, and a defect is formed in the adhesive layer on the component.

Suitable adhesives in accordance with the invention are all adhesives which can be applied uniformly to a support film, can be pre-cured thereon and can subsequently be transferred to the microstructured component. These are, for example, photopolymerisable adhesives, pressure-induced adhesives or preferably thermoplastic polymers. If necessary, the adhesives are firstly dissolved in suitable amounts of solvent for application to the support film. It is important that neither adhesive nor solvent partially dissolves the support film or causes stress cracking/crystallisation. The adhesives used in accordance with the invention exhibit lower adhesion to the support film than to the component. On use of thermoplastic polymers, their softening point or glass transition temperature is below that of the components and the support film.

The person skilled in the art is able to select a suitable support film and a suitable adhesive corresponding to-the material of the components. For components made from polycarbonate and in particular for components made from PMMA, suitable adhesives are, for example, polyethyl methacrylate, poly-n-propyl methacrylate, poly-n-butyl methacrylate or copolymers of these polymers with methyl methacrylate or preferably Plexigum N743 or Plexigum N742 (copolymers of methyl methacrylate and poly-n-butyl methacrylate) from Röhm, Germany.

Solvents are added to these polymers so that the latter have a viscosity which is suitable for the respective application method. Preference is given, for example, to a solution of 30 per cent by weight of Plexigum N743 in ethyl methyl ketone or a mixture of ethanol and ethyl methyl ketone (for example ethanol/ethyl methyl ketone, 90/10 (v/v)).

Accordingly, the term adhesive or adhesive layer is applied in accordance with the invention to photopolymerisable polymers, pressure-induced polymers or thermoplastic polymers or solutions of these polymers in solvents.

The adhesive layer is typically applied to the support film in a thickness of between 1 and 20 μm. The preferred thickness of the adhesive layer depends on the nature of the components to be bonded. If the components have a slight unevenness or roughness on the surface, a thicker adhesive layer (possibly greater than 20 μm) is preferably used in order to compensate for this unevenness. For less-rough components manufactured in an ideal manner, by contrast, a thickness of the adhesive application of from about 1 to 2 μm is usually sufficient.

The method according to the invention for joining components thus comprises the following steps:

a) Provision of the components:

These are usually two components, one of which is microstructured. However, it is also possible, for example, for the cover or base part to consist of two components.

b) Application of the adhesive layer to the support film:

The application of adhesive layers to polymer films, i.e. in accordance with the invention to a support film, is known to the person skilled in the art. The application is preferably carried out by means of knife coating or by means of methods known from printing technology, such as application via an embossed roll or printing unit. It is also possible for thin adhesive films to be, for example, extruded and then laminated onto a support film. The adhesive layer can also be laminated directly onto the support film. The transfer of the adhesive layer of defined thickness from the support film onto the microstructured component can be controlled significantly better than direct application of the adhesive to the component, since the viscosity of the adhesive is of lesser importance during application to the film.

c) Pre-curing of the adhesive:

The property of the adhesive can be modified on the film. In accordance with the invention, this is known as pre-curing. For example, the viscosity can be increased by evaporation of the solvent, pre-polymerisation, i.e. partial polymerisation, of the adhesive or complete polymerisation of the adhesive. In this way, the risk of the adhesive flowing into the microstructuring, i.e., for example, into channels, during application to the component is reduced.

d) Transfer of the adhesive layer from the support film to the microstructured component:

In this respect, it is of major importance that the adhesion of the adhesive layer to the support film is lower than that to the component. The microstructured component is then brought into contact with the film uniformly and completely at all points where there are no channels or notches due to the microstructuring. If desired, uniform pressure can be exerted in order to improve the transfer. Precise positioning of the support film with respect to the substrate is generally unnecessary for the adhesive transfer since the support film is covered uniformly with adhesive and can be significantly larger than the component.

The transfer can be simplified if the adhesive or tack properties of the adhesive are modified, for example by gentle heating on use of thermoplastic polymers. The adhesive thus temporarily becomes somewhat less viscous and can be transferred more easily. The warming can be carried out, for example, in an oven or alternatively by means of suitable radiation sources, such as IR or laser emitters or alternatively microwaves. To this end, the adhesive layer may additionally comprise absorbent additives, such as, for example, activated carbon.

It should be ensured that the heating is only carried out to a temperature which, although above the softening point or glass transition temperature of the adhesive layer, is below the softening point or glass transition temperature of the support film or target substrate, i.e. the component to be wetted. After the intermediate construction consisting of the microstructured component and the support film, which are joined by the adhesive layer, has been heated, this intermediate construction is cooled to below the softening point or glass transition temperature of the adhesive layer.

The support film is subsequently peeled off, with the adhesive being transferred completely to the component at the points where there was direct contact with the microstructured component. All points via which there will later be contact with the second component are thus covered or wetted with adhesive.

In some cases, the adhesive layer may be transferred as a complete film. This is undesired since the microstructuring, such as, for example, channels, would thus be covered by the adhesive layer. Although the second component subsequently placed on top could be joined to the microstructured component without problems, it would, however,. no longer be in direct contact with the channel structure of the microstructured component. The channel walls would thus no longer be formed by the same material on all sides, and electrodes on the component placed on top would not have direct contact with the channels. In order to exclude this, this component is, in a preferred embodiment of the method according to the invention, treated with compressed air or a corresponding gas stream after transfer of the adhesive to the microstructured component in order to blow off any adhesive layer lying over the channel structure. In just the same way, careful brushing-off of the adhesive layer lying over the channel structure with a soft brush is possible, depending on the nature of the adhesive.

e) Adjustment and joining of the components

After application of the adhesive, the second component is positioned in a suitable way with respect to the substrate and pressed on. To this end, the microstructured component, i.e. the substrate with the applied adhesive, is preferably held in a suitable device. For example, an exposure machine can be used for this purpose and the component held in the position otherwise intended for silicon wafers. On use of photochemically curing adhesives, the use of thick glass plates as pressing surface is preferred since in this way the positioning can be carried out directly and the photochemical curing of the adhesive can be carried out by irradiation, for example with an Hg lamp (emission wavelength 366 nm). The second component is held in the position intended for the exposure mask by holding it with a vacuum device milled into the glass plate. If, as preferred, both the components and the glass plates used for holding are transparent, the components can be adjusted through this arrangement, i.e., for example, the cover can be adjusted with respect to the substrate. If the cover projects beyond the substrate, this can also be held mechanically.

The positioning of the cover on the substrate can, for an adhesive operation, typically in addition to optical-mechanical adjustment with the aid of optical adjustment marks, also take place passively-mechanically with the aid of a snap-in device, optically-mechanically without particular adjustment marks or electrically-mechanically with the aid of electrical marks (contacts).

As disclosed in DE 199 27 533, metallic adjustment marks can be applied to the cover in the same process step with any electrodes required, i.e. preferably applied by sputtering. In this way, no additional expense is required for the application of adjustment marks. In the same process step, metallic absorber layers for later laser welding can also be applied. The corresponding counterstructures on the substrate likewise do not require additional processing since they are introduced into the substrate together with the channel structures in a casting step. For optical-mechanical adjustment, at least one component must consist of a transparent plastic. With the aid of the adjustment marks applied in accordance with the invention, the two components are positioned with an accuracy of at least ±10 μm, typically even ±2 μm (for example desired position to actual position of the detector electrode) with respect to one another and pressed together. The high positioning accuracy supports the attainment of reproducible analytical results.

g) Complete curing of the adhesive layer

The complete curing of the adhesive layer is carried out in accordance with the conditions necessary for the adhesive used. On use of thermoplastic adhesives, this can be carried out, for example, by heating the pressed-together components. The heating here should take place to a temperature at which the adhesive layer softens, but which is below the softening point or glass transition temperature of the components. The arrangement is subsequently cooled.

In the case of adhesives which have not yet been completely polymerised, the curing takes place by complete polymerisation.

In the case of photochemically curing adhesives, the curing takes place through irradiation with light of a suitable wavelength, for example using a UV lamp.

If the curing process of the adhesive is carried out outside the adjustment device used for positioning of cover and substrate, the metallised cover and the substrate, after they have been adjusted with respect to one another, can firstly be tacked by means of laser welding. The arrangement is then removed from the adjustment device, and the adhesive used is cured in a separate exposure apparatus or oven. This procedure means a process acceleration and simplification since the curing no longer has to be carried out in the adjustment device.

Further details on laser welding and corresponding preparation of transparent materials are given in DE 199 27 533.

The method according to the invention offers high process reliability. The individual steps are simple to carry out. In particular, the step of direct application of the adhesive layer to the structured component, which is necessary in the prior art, is avoided. The transfer of the adhesive layer of defined thickness from the support film to the microstructured component can be controlled significantly better than can direct application of the adhesive to the component.

Direct application of an adhesive, which is frequently of low viscosity, to a structured component can only be carried out by experts and with corresponding process control since there is a risk of the adhesive flowing into the microstructuring. In the same way, the placing of the second component on top must be carried out with great care in order that no adhesive enters the channels due to the pressure exerted. In addition, there is a risk of the adhesive partially dissolving the polymer substrate of the two components and thus of thin-film electrodes located on the second component being detached from their substrate.

Even without further details, it is assumed that a person skilled in the art will be able to utilise the above description in its broadest scope. The preferred embodiments and examples should therefore merely be regarded as descriptive disclosure which is absolutely not limiting in any way.

The complete disclosure content of all applications, patents and publications mentioned above and below, in particular the corresponding application DE 100 56 908.0, filed on 16.11.2000, is incorporated into this application by way of reference.

### EXAMPLE

A solution of Plexigum N743 from Röhm in ethyl methyl ketone (30% by weight) is applied uniformly to a Mylar® 250 A film from DuPont by means of a 20 μm hand coater from Erichson, Germany. The solvent evaporates in less than 1 minute at RT in a gentle stream of air. The dry Plexigum layer thickness is about 7 μm.

The film is subsequently placed with the coated side on the structured side of the component. This arrangement is subjected to a force of about 40 N with a component area of about 24 cm² between two metal plates and heated at 75° C. for 3 minutes in a fan-assisted oven. (It must be ensured that the temperature selected is above the softening point or glass transition temperature of Plexigum N743 (64° C.) and below the softening point or glass transition temperature of Mylar® 250 A (160° C.) and of the target substrate (PMMA, 100° C.).)

After cooling to below the softening point or glass transition temperature of the adhesive layer, i.e. to about 30° C., the Mylar® film is peeled off. The thin adhesive layer remains in its entirety on the PMMA surface of the microstructured component. This surface later forms the contact surface to the second component. An adhesive film located partly over the channels is blown off using clean-room compressed air (3 bar).

The microstructured component provided with the adhesive layer is held in a modified exposure machine at the point at which a silicon wafer is usually located. A second PMMA component provided with thin-film electrodes, which is to be regarded as electrode cover, is likewise held in the exposure machine by means of a vacuum glass holder. This glass holder adopts the position which, in normal operation, is intended for the exposure mask. Firstly, the two components are suitably positioned with respect to one another and then brought into contact in such a way that the second component is in direct contact with the adhesive layer of the microstructured component. The components are then pressed against one another at a force of about 20 N using a simple lever mechanism. In order to cure the adhesive completely, the two joined components are again heated to a temperature (here: 75° C.) above the softening point or glass transition temperature of Plexigum N743 and below the softening point or glass transition temperature of PMMA for about 5 minutes. The arrangement is subsequently cooled to about 30° C.

A flow unit consisting of two components which are joined to one another in a liquid-tight manner and whose channel structure has PMMA walls is obtained. The electrodes integrated into the channel system are positioned accurately and have no contamination due to adhesive.

1. Method for joining components, characterised by the following steps:
a) provision of at least two components, where at least one component is microstructured;
b) application of an adhesive layer to a support film;
c) pre-curing of the adhesive layer on the support film;
d) transfer of the adhesive layer from the support film to at least one microstructured component;
e) adjustment and joining of the components;
f) complete curing of the adhesive layer.

2. Method according to claim 1, characterised in that the components provided in step a) consist of plastic.

3. Method according to one of claims 1 and 2, characterised in that the application of the adhesive layer to the support film in step b) is carried out by means of roller application, knife coating or pad printing.

4. Method according to one of claims 1 to 3, characterised in that the transfer of the adhesive layer to at least one microstructured component (step d)) is followed by an intermediate step d2) in which parts of the adhesive layer lying over the microstructuring are blown off using compressed air or removed using a brush.

5. Method according to one of claims 1 to 4, characterised in that the transfer of the adhesive layer from the support film to at least one microstructured component in step d) is carried out by joining the support film and the microstructured component, heating the arrangement to a temperature at which the adhesive layer softens, but which is below the softening point or glass transition temperature of the component and support film, cooling the arrangement, and peeling off the support film.

6. Method according to one of claims 1 to 5, characterised in that the complete curing of the adhesive layer in step f) is carried out by heating the joined components to a temperature at which the adhesive layer softens, but which is below the softening point or glass transition temperature of the components, and subsequently cooling the arrangement.

7. Method according to one of claims 1 to 6, characterised in that an adhesive layer having a thickness of from 1 to 20 μm is applied in step b).
